(19) United States
(12) Patent Application Publication
(10) Pub. No.: US 2003/0162523 A1
(43) Pub. Date: Aug. 28, 2003

(54) Vehicle telemetry system and method

(76) Inventors: Michael Kapolka, Sterling Heights, MI (US); Rick Beyer, Reston, VA (US); Jack Schang, Ponte Vedra Beach, FL (US); John Allard, Manchester, NH (US)

Correspondence Address: MCDONNELL BOEHNEN HULBERT & BERGHOFF, 300 SOUTH WACKER DRIVE, SUITE 3200, CHICAGO, IL, 60606, US

(21) Appl. No.: 10/084,800

(22) Filed: Feb. 27, 2002

(51) Int. Cl. H04B 1/06

(52) U.S. Cl. 455/345; 455/557

(57) ABSTRACT

A vehicle telemetry system allows remote access to information and services relating to the operation and performance of one or more vehicles. Information from a telemetry module mounted on a vehicle is received by an application service provider via wireless communication, where it is processed by one or more computer servers. Users then access the computer servers through various means, such as the Worldwide Web, in order to obtain various telemetry data relating to the vehicle(s).

### FIELD OF THE INVENTION

The present invention relates to the field of vehicle telemetry. More specifically, the invention relates to a system and method for users to remotely-access various information and services relating to the operation and performance of one or more vehicles.

### BACKGROUND OF THE INVENTION

On-board vehicle telemetry systems are known in the commercial vehicle industry. In general, vehicle telemetry systems facilitate data or information transfer between a vehicle and a remotely-located user. The user typically receives data from and/or sends data to a vehicle through a personal computer, personal digital assistant (PDA), or other electronic device. Various vehicle telemetry systems can be used to communicate various types of information, such as vehicle security information, vehicle position/location, driver trip information, jurisdiction boundary crossing information, fuel consumption information, driver-messaging, concierge services, and information relating to remote diagnostics, such as monitoring the wear and tear of the vehicle and its various components, among others.

FIG. 1 illustrates the major components of a typical vehicle telemetry system, as well as the categories of costs associated with implementing such a system. An on-vehicle telemetry module 1, including hardware and software, is mounted to a vehicle 2. The telemetry module 1 receives information from and transmits information to various sensors, monitors, electronic controllers, and other electronic devices on the vehicle, typically through a central vehicle data bus. The telemetry module 1 is capable of wireless communication to a user 5 via a wireless communication service provider 3. The user 5 uses a personal computer, personal digital assistant (PDA) or other electronic device to communicate with the vehicle telemetry module 1. The personal computer or PDA runs application-specific software 4 adapted to receive, organize, store, transmit, and otherwise facilitate communication of data to and from the telemetry module 1.

Communication between a user 5 and a vehicle 2 can be two-way in the sense that information can be transmitted from the telemetry module 1 to the user 5, and the user 5 can transmit information to the telemetry module 1. For example, various types of information relating to the vehicle operation, such as wear and tear information, trip information, and maintenance information, can be transmitted from the telemetry module 1 to the user 5. Similarly, various types of information, such as messages, vehicle operation and maintenance settings (speed governor settings, for example), can be determined and sent from the user 5 to the telemetry module 1.

As illustrated in FIG. 1, there are several types of costs associated with implementing and maintaining a vehicle telemetry system. Such costs include the costs associated with purchasing, installing, managing, and maintaining the software and hardware necessary for a user 5 to receive information from and send information to the telemetry module 1. Known telemetry systems typically require application-specific software to be installed on the computer (or other electronic device) used by the user 5 to process telemetry data and communicate with the telemetry module 1. Further, a wireless communication service 3 must be employed to enable the wireless communication between the telemetry module 1 and the user 5. A wireless communication system typically involves various fees, including an activation fee, monthly fees, and data fees. Finally, the telemetry module 1 and related hardware and software installed on the vehicle 2 is itself costly. All of these costs are referred to herein as the “Total Cost of Ownership” of a vehicle telemetry system.

Until this invention, all known vehicle telemetry systems have required a single entity, typically the owner of the vehicle(s) upon which the telemetry system is installed, to bear the Total Cost of Ownership. For example, a corporate vehicle fleet operator wanting to implement a vehicle telemetry system would be required to purchase office application-specific software, install telemetry hardware and software on the vehicles, contract with a third-party wireless communication service provider, and assume responsibility for maintaining the equipment and services. Further, when improvements have been added to the telemetry system, such as enhanced features or upgraded software packages, the same entity has typically been required to bear the cost and inconvenience of purchasing, installing, and upgrading its equipment.

The inventors hereof have recognized that many entities, other than just the vehicle owner, can benefit from the implementation of a vehicle telemetry system. For example, vehicle component manufacturers can obtain real-life information about how their components perform and wear during operation, and they can provide proactive support of their components prior to or during a breakdown or product update. Vehicle manufacturers can learn real-life information about their products, and they can offer additional services to their customers, such as managed service, fleet management and asset management systems. Leasing companies can locate and monitor the use of their vehicles, and they can be notified of use or abuse events. Fleet operators can track the location of vehicles and shipments, monitor the status of the vehicle, implement maintenance scheduling programs based upon the operating condition of the vehicle, and contact the driver via messaging systems. Recognizing that the benefits of an on-vehicle telemetry system can be wide-spread, the inventors have recognized the need to distribute the Total Cost of Ownership among various potential users of the system, thereby lowering the cost of the telemetry system to the vehicle owner, as well as each of the other potential users of the telemetry system. Accordingly, the inventors hereof have developed the improved vehicle telemetry system and method described herein.

### SUMMARY OF THE INVENTION

The invention is directed to a new system and method for vehicle telemetry. The new system includes a vehicle telemetry module mounted to a vehicle for receiving and/or transmitting information relating to the vehicle's operation. The new system also includes a remotely-located computer server for receiving the vehicle operation information from the telemetry module via wireless communication and then providing the vehicle operation information to a plurality of users who are remotely-located from the computer server. This same remotely-located computer server can send instructions to the vehicle telemetry module based upon user requests or instructions. In certain embodiments of the invention, various fees can be charged to the various users who access telemetry information from the computer server.

### BRIEF DESCRIPTION OF THE DRAWINGS

In the drawings:

FIG. 1 is a simplified depiction of the general components included in a typical vehicle telemetry system and how their associated costs are allocated in a traditional configuration.

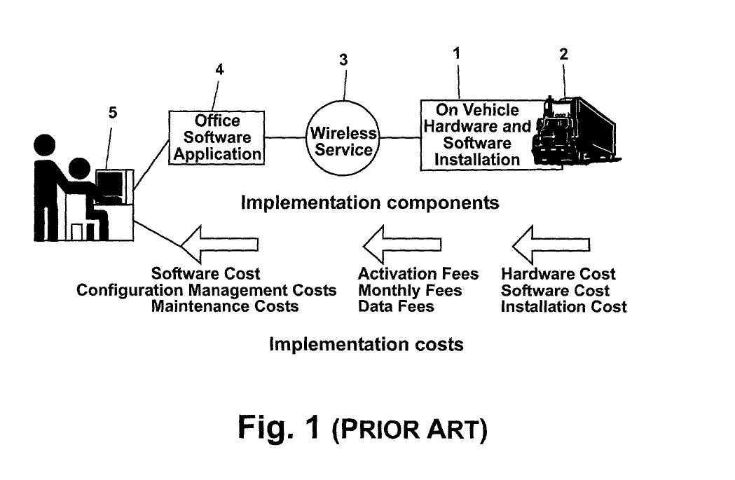

FIG. 2 is a simplified depiction of a vehicle telemetry system embodying the present invention, according to a preferred embodiment.

FIG. 3 is a simplified depiction of the general components of a vehicle telemetry system and how their associated costs are allocated in a configuration represented by a preferred embodiment of the present invention.

FIG. 4 is a table depicting an example fee arrangement for various users based on the vehicle telemetry functions they elect to perform or have access to under a preferred embodiment of the invention.

### DESCRIPTION OF THE PREFERRED EMBODIMENT

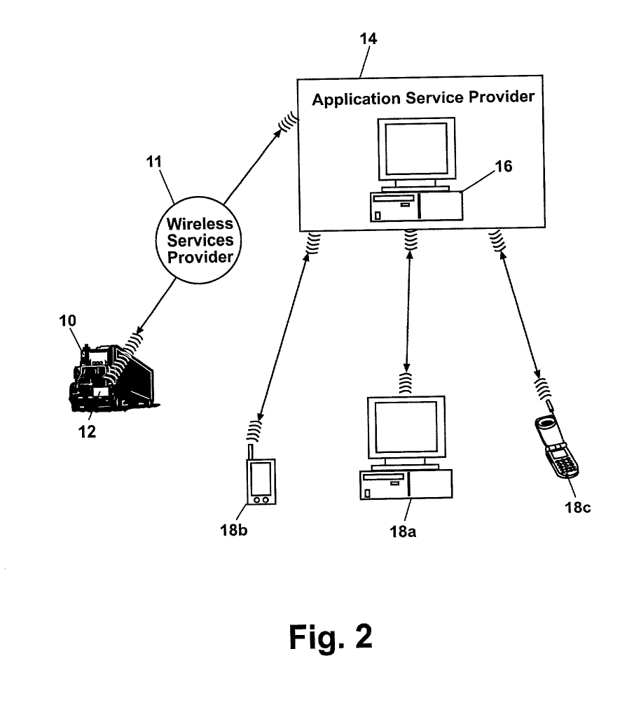

A simplified setup of a vehicle telemetry system in accordance with the present invention is depicted in FIG. 2. An on-vehicle telemetry module 12 is mounted to a vehicle 10. The telemetry module 12 includes, or is otherwise connected to, a device having wireless transmission and reception capabilities. The telemetry module 12 comprises an access point for various forms of vehicle information. According to a preferred arrangement, the telemetry module 12 can be connected to, or otherwise arranged so as to be in communication with, a central data bus (not shown) on the vehicle 10, allowing it to access and process various types of data relating to the different electronic or electronically-monitored systems of the vehicle. The telemetry module 12 can also act as a gateway for receiving information, such as control/adjustment commands, from a remote source and providing such information to various electronic controllers (not shown) that control the operation of the vehicle 10. One known commercially-available telemetry module is the PRISM™ on-vehicle computer used in connection with the ETECHNICIAN™ telemetry system, available commercially from Nexiq Technologies, located in Sterling Heights, Mich.

The telemetry module 12 is in wireless communication with an application service provider (ASP) 14, wherein one or more computer servers 16 are maintained for processing and storing telemetry data received from the telemetry module 12. A wireless service provider 11 facilitates the wireless communication between the ASP 14 and the telemetry module 12. Users 18 subscribe to various services offered by the ASP 14, wherein the users 18 can access various pieces of telemetry information stored by the ASP 14 on the computer server 16. Users 18 can use a variety of devices to access the telemetry data stored on the computer server 16, including, for example, personal computers 18a, PDAs 18b, and wired or wireless telephones 18c. The users 18 are remotely-located from the computer server 16; specifically, they are not directly connected via physical cables to the same local area network (LAN). Preferably, users 18 communicate with the computer server 16 via a wide area network, such as the Internet, using a common software package, such as a Web browser. Users 18 can also cause adjust/control commands and other information to be transmitted to the telemetry module 12.

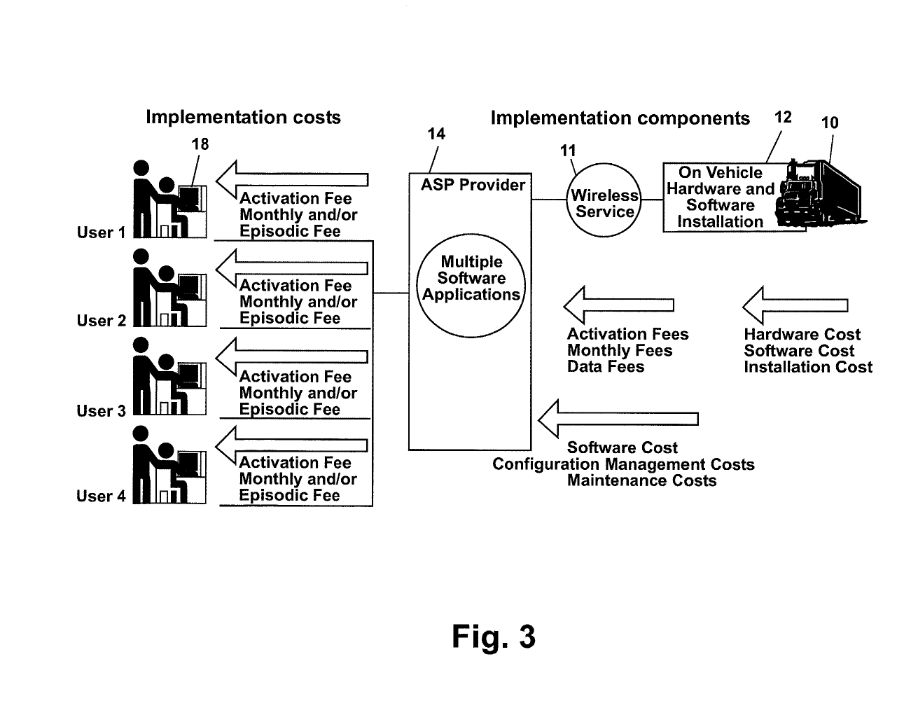

FIG. 3 sets forth a simplified illustration of a preferred embodiment of the present invention in operation, including a preferred method of distributing the Total Costs of Ownership of a vehicle telemetry system. The ASP 14 purchases and maintains various application-specific software packages necessary to receive, transmit, process, and store telemetry data from a vehicle 10. Further, the ASP 14 contracts for and maintains a wireless communication service 11 that facilitates wireless communication between the telemetry module 12 of vehicle 10 and the computer server 16 of ASP 14. The ASP 14 is responsible for all of the costs associated with the installation of the on-vehicle telemetry module 12 (including hardware and software costs). The ASP 14 is further responsible for all of the costs associated with purchasing, installing, and maintaining the software necessary to receive, process, and store telemetry data. Thus, the ASP 14 preferably bears the Total Cost of Ownership of the telemetry system.

The ASP 14 allows various users 18 to access telemetry information stored on the computer server 16 for a fee. The ASP 14 may also allow the users 18 to provide adjustment/control commands to telemetry module 12, which then can download such adjustment/control commands to various electronic controllers on the vehicles 10. The users 18 may include, for example, the vehicle owner, the vehicle manufacturer, various component manufacturers, fleet managers, etc. Each of the users 18 can access all of the stored telemetry information or a subset thereof, depending upon each of the preferences of the individual users. Thus, the users 18 can elect to receive the various portions of the available information that are most useful to them.

The ASP 14 charges a fee to the users 18 to access the telemetry information received from the vehicle 10 and to send control/adjustment commands to the vehicles. The ASP 14 can devise various subscription fee arrangements, preferably based upon a system-usage level. For example, the fee for a given user can be based upon the particular type of information accessed by the user, the number of times that the user accesses information, the quantity of information accessed by the user, etc. Further, the fee structure can include one-time activation fees, a monthly base fee, etc. Many different fee arrangements are possible within the scope of this invention.

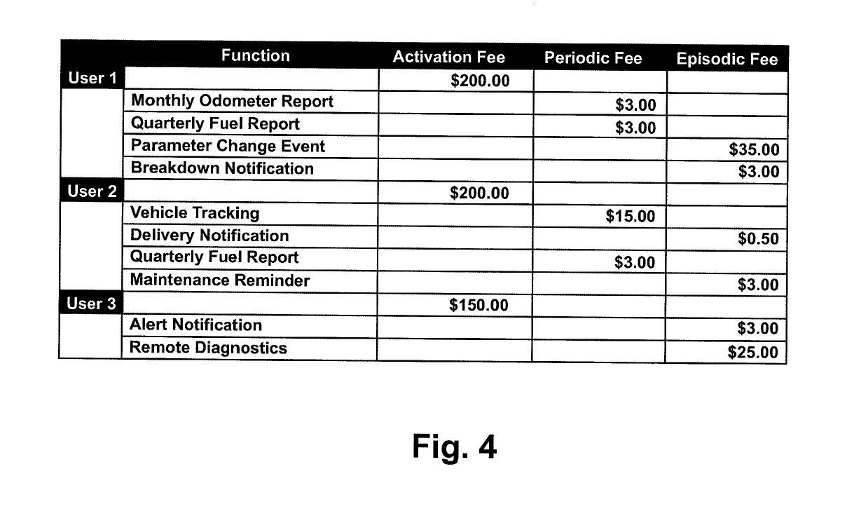

FIG. 4 illustrates a sample fee structure for service requests by three hypothetical users of a given vehicle telemetry system. As set out in FIG. 4, a first user of the telemetry system may request the following information from the vehicle: (i) monthly odometer report; (ii) quarterly fuel report; and (iii) notification of any vehicle breakdown. The first user may also cause a vehicle parameter, such as the governor speed to be changed. Sample fees charged for these various services are set forth in FIG. 4. For example, the first user may pay a flat activation fee of $200.00, a periodic fee of $3.00 for receiving odometer and fuel reports periodically, and episodic fees of $35.00 and $3.00 each time the first user causes a vehicle operating parameter to be changed or receives a breakdown notification, respectively. FIG. 4 further illustrates how different users can subscribe to receive different selected pieces of information and transmit different selected commands and settings. For example, User #2 in FIG. 4 is shown as subscribing to receive vehicle tracking information, notifications of package deliveries, quarterly fuel reports, and maintenance reminders. Similarly, User #3 is shown as subscribing to receive alert notifications and remote diagnostics information.

The described embodiment of the present invention provides many benefits over known vehicle telemetry systems and methods. For example, users no longer are required to bear the various costs associated with the Total Cost of Ownership. Rather, the Total Cost of Ownership is preferably born by the ASP, and the various beneficiaries of the telemetry system can subscribe to portions of the system, and pay proportionate fees according to their respective usage-levels. Further, users can easily change the level of their service subscription as their needs change. Thus, users can easily upgrade their services if their needs increase, or they can downgrade their services if their needs decrease. In either situation, the user does not have to invest in expensive fixed equipment. On of ordinary skill in the art will recognize additional benefits of the present invention.

While the invention has been specifically described in connection with certain specific embodiments thereof, it is to be understood that this is by way of illustration and not of limitation, and the scope of the appended claims should be construed as broadly as the prior art will permit.

What is claimed is:

1. A vehicle telemetry system, comprising:
an on-vehicle telemetry module, adapted to receive information relating to operation of said vehicle; and
a computer server, remotely-located from said vehicle, adapted to receive said vehicle operation information from said telemetry module via wireless communication, and further adapted to provide said vehicle operation information to a plurality of users remotely-located from said computer server.

2. The vehicle telemetry system of claim 1, wherein said telemetry module is in electronic communication with a vehicle data bus, and wherein said telemetry module receives said operation information from said data bus.

3. The vehicle telemetry system of claim 1, wherein said computer server is capable of providing a selected portion of said vehicle operation information to at least one of said users, wherein said selected portion of said vehicle operation information is tailored to a request from said one of said users.

4. The vehicle telemetry system of claim 1, wherein said vehicle operation information is provided to said remotely-located users via a wide-area network.

5. The vehicle telemetry system of claim 4, wherein the wide-area network is the Internet.

6. The vehicle telemetry system of claim 5, wherein said users access said vehicle operation information using a Web browser.

7. The vehicle telemetry system of claim 1, wherein said vehicle operation information is provided to said users from said computer server via telephone communication lines.

8. The vehicle telemetry system of claim 1, wherein said vehicle operation information is provided to said users from said computer server via wireless communication.

9. The vehicle telemetry system of claim 1, wherein said computer server is adapted to provide said vehicle operation information to said users via an electronic device chosen from the following group: personal computer, personal digital assistant, and mobile phone.

10. The vehicle telemetry system of claim 1, wherein said computer server is further adapted to receive user-originated control commands relating to vehicle operation, and wherein said computer server is further adapted to provide said user-originated control commands to said telemetry module via wireless communication.

11. A method for providing vehicle operation information to a plurality of users, comprising the steps:
receiving vehicle operation information from a remotely-located vehicle via wireless communication;
receiving requests for said vehicle operation information from a plurality of remotely-located users; and
providing access to said vehicle operation information to said remotely-located users.

12. The method of claim 11, wherein requests for said vehicle operation information includes at least one request from one of said users for a selected subset of said vehicle operation information, and wherein said step of providing access to said vehicle operation information comprises providing access only to said selected vehicle operation information subset to said one of said users.

13. The method of claim 11, wherein said users are permitted to request different selected subsets of said vehicle operation information, and wherein said step of providing access to said vehicle operation information comprises providing access to said selected subsets of vehicle operation information corresponding to said requests.

14. The method of claim 11, further comprising the step of charging each of said users a fee for said access to said vehicle operation information.

15. The method of claim 14, wherein said fee for each user is variably-determined based upon a system usage-level of said corresponding user.

16. The method of claim 15, wherein said system usage-level is determined based upon an amount of vehicle operation information requested by said corresponding user.

17. The method of claim 15, wherein said system usage-level is determined based upon a type of vehicle information requested by said corresponding user.

18. The method of claim 15, wherein said system usage-level is determined based upon a number of times over a given time period that said user accesses said vehicle operation information.

19. The method of claim 11, wherein said access to said vehicle operation information is provided via a wide area network.

20. The method of claim 19, wherein said wide area network is the Internet.

21. The method of claim 11, wherein access to said vehicle operation information is provided via a telephone communication line.

22. The method of claim 11, wherein, access to said vehicle operation information is provided via wireless communication.

23. The method of claim 11, wherein said vehicle operation information includes information relating to a performance characteristic of a vehicle component.

24. The method of claim 11, wherein said vehicle operation information includes information relating to a location of said vehicle.

25. A method of operating a vehicle telemetry system, comprising the steps:
causing a vehicle telemetry module to be installed on a vehicle, wherein said vehicle is owned by a first entity;
receiving vehicle operation information from said telemetry module via wireless communication;
storing said vehicle operation information on a computer server remotely-located from said vehicle; and
providing access to said vehicle operation information stored on said computer server to a second entity.

26. The method of claim 25, further comprising the step of charging a fee to said second entity for said access to said vehicle operation information.

27. The method of claim 26, wherein said fee is related to a system-usage level corresponding to said second entity.

28. The method of claim 25, wherein said computer server is owned by a third entity.

29. The method of claim 25, wherein said computer server is maintained by a third entity.

30. The method of claim 25, wherein said second entity is remotely-located from said computer server.

31. The method of claim 25, wherein said second entity accesses said vehicle operation information via a wide area network.

32. The method of claim 31, wherein said wide area network is the Internet.

33. A method of operating a vehicle telemetry system, comprising the steps:
causing a vehicle telemetry module to be installed on a vehicle;
establishing wireless communication between said vehicle telemetry module and a computer server remotely-located from said vehicle;
receiving a vehicle control command from a user who is remotely-located from said computer server; and
causing said computer server to transmit said vehicle control command to said vehicle telemetry module.

34. The method of claim 33, further comprising the step of charging a fee to said user for said transmission of said vehicle control command.

35. The method of claim 33, wherein:
said vehicle is owned by a first entity;
said computer server is owned by a second entity; and
said user is a third entity.

36. The method of claim 33, wherein said user provides said vehicle control command to said computer server via a wide area network.

37. The method of claim 36, wherein said wide area network is the Internet.
